(19) United States
(12) Patent Application Publication
(10) Pub. No.: US 2012/0135387 A1
(43) Pub. Date: May 31, 2012

(54) DENTAL EDUCATIONAL APPARATUS AND METHOD

(75) Inventors: Kevin Morrow, Jacksonville, FL (US); David Michael Reynolds, Savannah, GA (US); Mark Elliott Jervis, Rincon, GA (US)

(73) Assignee: STAGE FRONT PRESENTATION SYSTEMS, Savannah, GA (US)

(21) Appl. No.: 12/955,878

(22) Filed: Nov. 29, 2010

(51) Int. Cl. G09B 23/28; G09B 5/06

(52) U.S. Cl. 434/263

(57) ABSTRACT

Apparatus for generating and recording video and audio associated with a dental procedure such as a dental or medical procedure comprises a video camera comprising a lens including an outermost refractive element. A light source comprises a plurality of light emitting devices. The light source is positioned adjacent the lens. The lens comprises an outer cylindrical surface. The outer cylindrical surface serves as a shade preventing light from entering the outermost refractive element. A support member supports the video camera at a plurality of positions. The instructor computer is coupled to the video camera for recording video output by the video camera. An instructor graphics input device is coupled to the computer for inputting graphical representations generated by the instructor into the instructor computer for inclusion in the video.

### TECHNICAL FIELD

The invention relates to apparatus and methods for dental education through the use of a video camera coupled to an interactive web-based or LAN system backbone.

### CROSS REFERENCE TO RELATED APPLICATIONS

(Not applicable)

### STATEMENT REGARDING FEDERALLY SPONSORED RESEARCH OR DEVELOPMENT

(Not applicable)

### BACKGROUND OF THE INVENTION

For many years, numerous systems have utilized relatively modern technologies, such as video technology and/or the Internet. Nevertheless progress continues to be made in the development of systems and methodologies aimed at obtaining increased effectiveness from these relatively modern technologies.

### SUMMARY OF THE INVENTION

Turning to the field of education, and dental education in particular, it has recently been proposed that a camera can be mounted on a conventional dental illumination source for the purpose of generating images to generate dental images for the purpose of motivating patients, and to document procedures to “prove” dental student errors. Such systems are also proposed to demonstrate dental procedures by sending video with accompanying audio to video screens or over networks to, presumably, remote locations. See Third Eye Dental Cameras, http://www.dental-cameras.com/index.php?lang=eng. While such techniques are interesting they do not really go beyond the conventional patient motivational techniques of mirrors and still photography. With respect to dental educational applications, here again these currently discussed applications do not really add to conventional cluster observation conducted in conventional educational settings.

In accordance with the invention, a method is provided to more effectively leverage the capabilities of audiovisual systems. The same is achieved through the use of software and hardware subsystems and operational protocols that produce results not previously achieved with conventional teaching methods.

More particularly, in accordance with the methodology and structural features of the present invention, not only is audio and video collected at the instructor-demonstration point, but provision is made for interactive audio colloquy, interactive computer-assisted visual issue indications, interactive colloquy and/or computer-assisted system control, and recording of the above elements, associated with numerous instructor and/or student participants to generate comprehensive, clear and library-ready instructional pieces in a time efficient manner.

The inventive apparatus for generating and recording video and audio associated with a dental procedure comprises a video camera comprising a lens including an outermost refractive element. A light source may comprise a single light source, such as a single light emitting diode, or a plurality of light emitting devices. Use of a higher power light emitting diode or a plurality of light emitting diodes may be preferred if, in addition to providing an audiovisual output, it is desired for the device of the invention to be used as a general purpose dental light. The light source is positioned adjacent the lens. The lens comprises an outer cylindrical surface. The outer cylindrical surface serves as a shade preventing light from entering the outermost refractive element. A support member supports the video camera at a plurality of positions. The instructor computer is coupled to the video camera for recording video output by the video camera. An instructor graphics input device is coupled to the computer for inputting graphical representations generated by the instructor into the instructor computer for inclusion in the video.

### BRIEF DESCRIPTION THE DRAWINGS

The operation of the invention will become apparent from the following description taken in conjunction with the drawings, in which:

FIG. 1 is a perspective view of the inventive dental video recording unit, which may serve as a general-purpose dental light;

FIG. 2 is a front plan view of a dental video system in accordance with the present invention;

FIG. 3 is a detail illustrating the placement of the camera lens and lighting in the case of a dental video unit also meant for use as a general dental light on account of the use of a large number of light emitting diodes;

FIGS. 4-8 illustrates an optional illumination scheme suitable to be implemented according to the present invention;

FIG. 9 illustrates a remote control useful in connection with the inventive video unit;

FIG. 10 illustrates the inventive dental video unit in the context of a networked teaching environment; and

FIG. 11 is a flow chart generally illustrating an implementation of the methodology of the present invention.

### DETAILED DESCRIPTION OF THE PREFERRED EMBODIMENTS

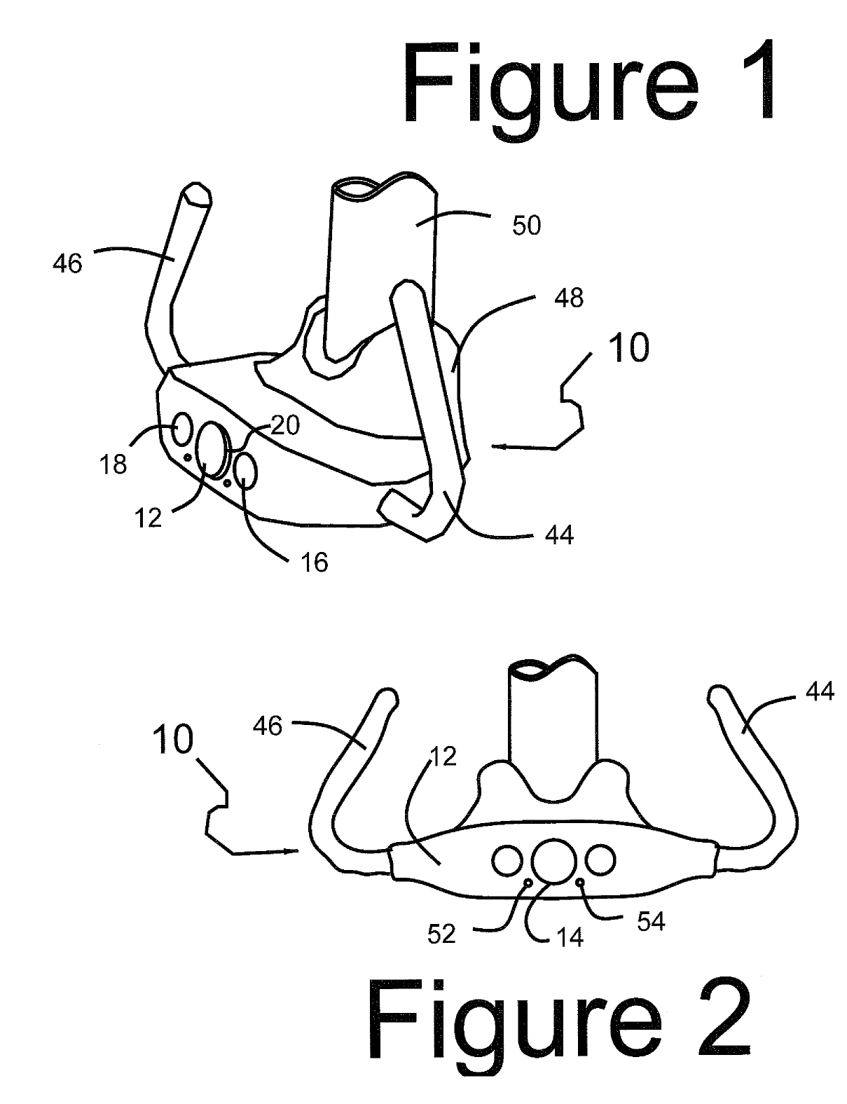

Turning to FIGS. 1 and 2, a dental video unit 10 constructed in accordance with the present invention and adapted for use in the inventive educational system is illustrated. Dental video unit 10 comprises a housing 12, which functions to house the operative components of dental video unit 10.

FIG. 2 illustrates the forwardmost portions of the inventive dental video unit 10. These operative components comprise a high definition video camera whose lens 14 extends from housing 12. Illumination for the camera is provided by light emitting diode arrays 16 and 18. These may comprise a pair of single light emitting diodes, as would be sufficient to provide light for a camera unit and demonstration. However, the invention also contemplates that the inventive video camera unit may be used as a general illumination device for dentistry, and in such case a greater light output would be desirable and the same is provided by the illustrated pair of rings of light emitting diodes.

While the input face of lens 14 is substantially in the same plane as the light emitting diode arrays 16 and 18, the exposed portion 20 of the cylindrical housing of lens 14 extends somewhat forward of light emitting diode arrays 16, and somewhat forward of the forwardmost refractive element 22 of lens 14 and 18, and thus acts as a barrier to prevent direct input of the output of light emitting diode arrays 16 and 18 into the forwardmost refractive element 22 of lens 14. Thus, exposed portion 20 of the cylindrical housing of lens 14 acts as a cowl to prevent direct illumination of lens 14.

At the same time, because the forwardmost refractive element 22 of lens 14 is in substantially in the same plane as light emitting diode arrays 16 and 18, no shadows and resultant loss of illumination is created by the positioning of forward portion of exposed portion 20 of the cylindrical housing of lens 14.

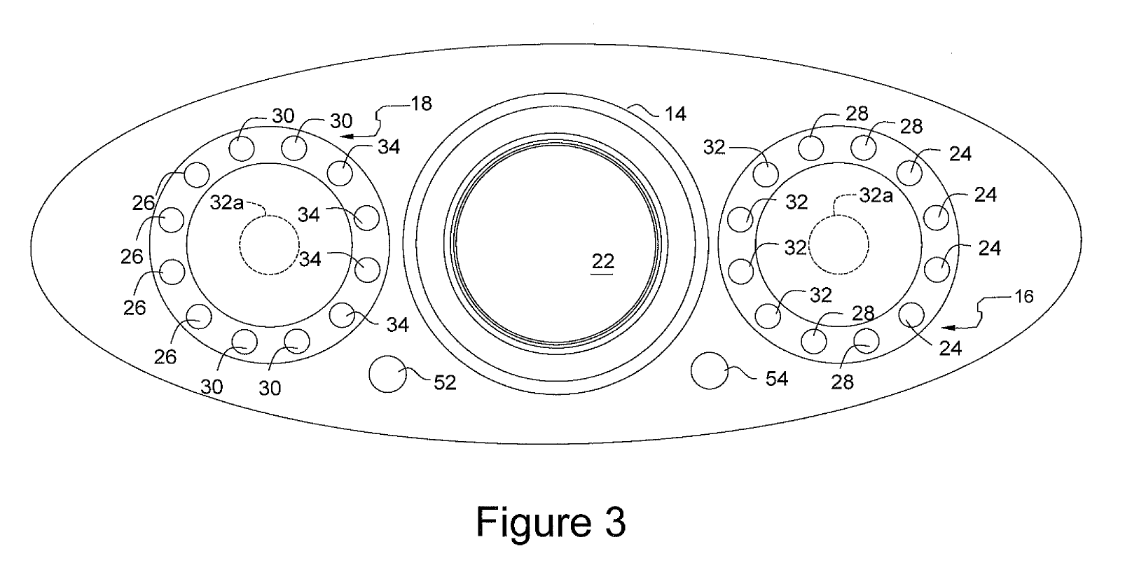

As can be seen with reference to FIG. 3, in accordance with one illustrated embodiment of the invention, light emitting diode arrays 16 and 18 each comprise a plurality of individual light emitting diodes 24, 26, 28, 30, 32 and 34. In accordance with a preferred embodiment, light emitting diodes 24, 26, 28, 30, 32 and 34 are provided with convex lenses (not illustrated) which are positioned over light emitting diodes 24, 26, 28, 30, 32 and 34, and focus their output.

The use of fewer or more light emitting diodes is within the contemplation of the present invention. For example a single pair of light emitting diodes 32a will provide sufficient light for video, and a single pair of stronger light emitting diodes will serve the purpose of general dental illumination. Lenses and/or reflectors may be employed with any light emitting diode array and conventional spherical lenses or cylindrical lenses, or any other focusing device, such as a concave reflector may be employed.

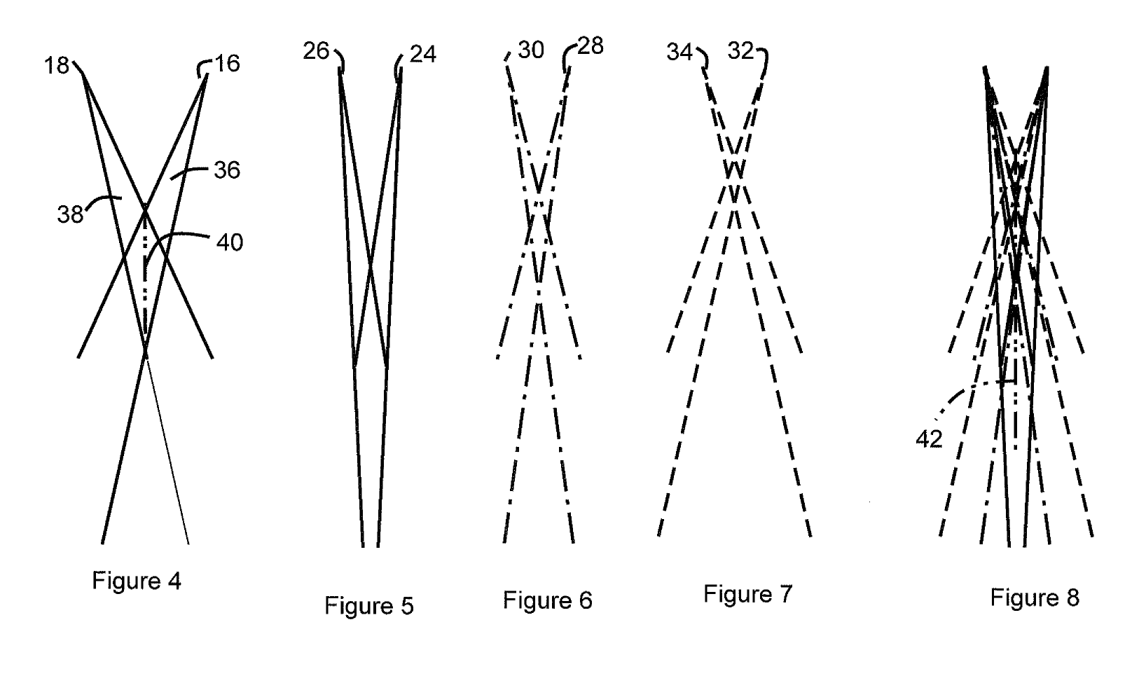

In accordance with the present invention, it is contemplated that light emitting diode arrays 16 and 18 would be aimed to illuminate the area of primary interest during use of inventive dental video unit 10. More particularly, as illustrated in FIG. 4, it is contemplated that the lights in array 16 would be aimed to form a cone of light 36. At the same time, the light emitting diodes in array 18 would be aimed to form a cone of light 38. The combined effect such an arrangement is the illumination of a region of interest 40, within which the dental work being video recorded is positioned. In accordance with the invention, the range of positions which can be accommodated by the system may be adjusted by varying the positions of arrays 16 and 18, as well as their orientations and the widths of the cones of light which they produce.

In accordance with an alternative embodiment of the invention light emitting diodes 24, 26, 28, 30, 32 and 34, may be focused to create relatively narrow cones of light oriented to illuminate dental work at different distances from inventive dental video unit 10. More particularly, light emitting diodes 24 and 26 may be oriented to illuminate dental work at a relatively distant position, as illustrated in FIG. 7. Similarly, light emitting diodes 28 and 30 may be oriented to illuminate dental work at a somewhat closer position, as illustrated in FIG. 6. Finally, light emitting diodes 32 and 34 may be oriented to illuminate work at relatively close positions, as illustrated in FIG. 8.

The overall effect of illumination from the light emitting diodes is illustrated in FIG. 8. The result is effective illumination of a region 42. Generally, in FIGS. 4-7 and 8, output cones of light are illustrated with overlapping cones showing particular areas to be illuminated.

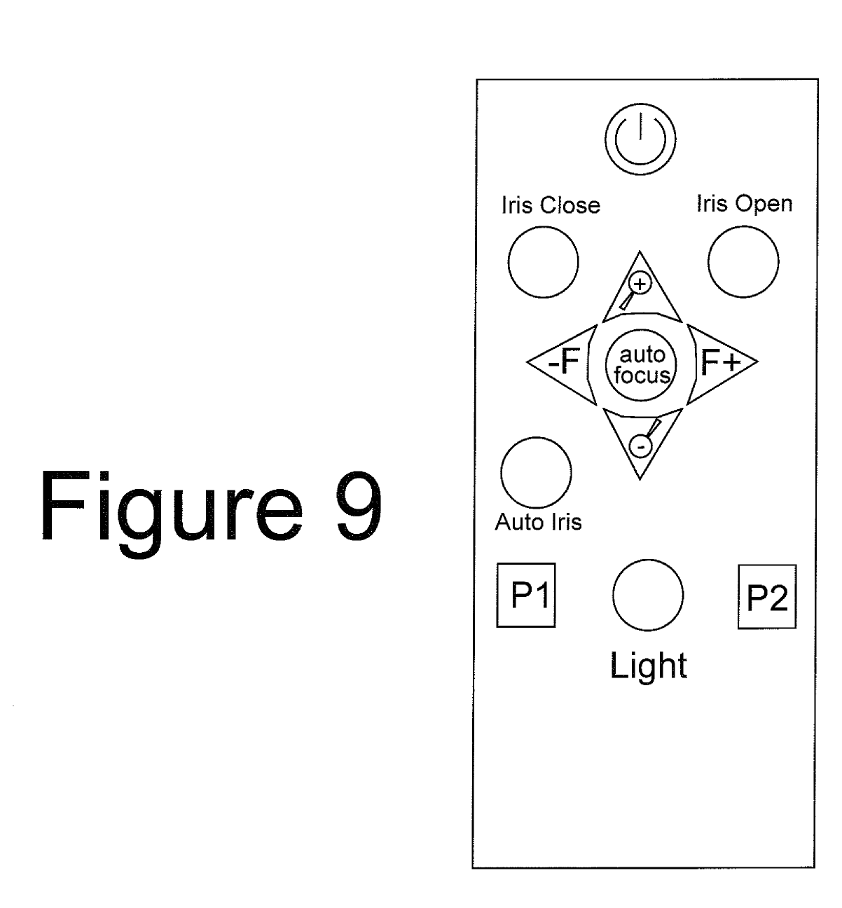

Referring to FIG. 9, a remote control device may be provided for operation of the inventive system. The same would include buttons clearly labeled to show their function, including an on/off button, a button for opening the iris, a button for closing the iris, and a button for allowing the system to automatically adjust the opening of the iris. Likewise, autofocus may be button selected from the remote control and focusing may be controlled by the button labeled with −F to focus in closer, and +F to focus out further. Likewise, a magnifying glass icon may be used in conventional fashion to zoom in and zoom out.

A light may be turned on by a light on/off button and presets may be set in conventional camera fashion by P1 and P2 buttons. The light on/off button can also increase and decrease the light level, by, for example, by rotation. Presets store camera settings, lens settings, light level and light on/off state,

In accordance with the present invention, optionally, limited numbers of light emitting diodes may be eliminated. For example, if the area of interest is relatively far from inventive dental video unit 10, light emitting diodes 24 and 26 may only be illuminated. Light emitting diodes 28 and 30, alone, may do excellent service to illuminate relatively closer areas. Even closer areas could be addressed only by light emitting diodes 32 and 34.

The determination the position of the dental work to be illuminated and the consequent selection of which light emitting diodes ought to be activated may be done in response to an autofocus signal associated with the camera associated with lens 14. This has the advantage of conserving power and, perhaps more importantly, minimizing stray light output by the system, which can be uncomfortable for the patient.

Returning to FIGS. 1 and 2, inventive dental video unit 10 includes a pair of arms 44 and 46. Dental unit 10 may be supported on a socket support 48, which mates with a u-bracket at the end a vertical support number 50.

Dental video unit 10 may be mounted on an articulated support, for example of the type comprising a plurality of boom members joined to each other by one or a plurality of, for example two pivot joints. Alternatively, any conventional support mechanism useful with a dental lighting system may be used.

The inventive system may be turned on and off by a switch. A power indicator 52 indicates when the system is on. A microphone 54 captures an audio signal, for example, the voice of the instructor.

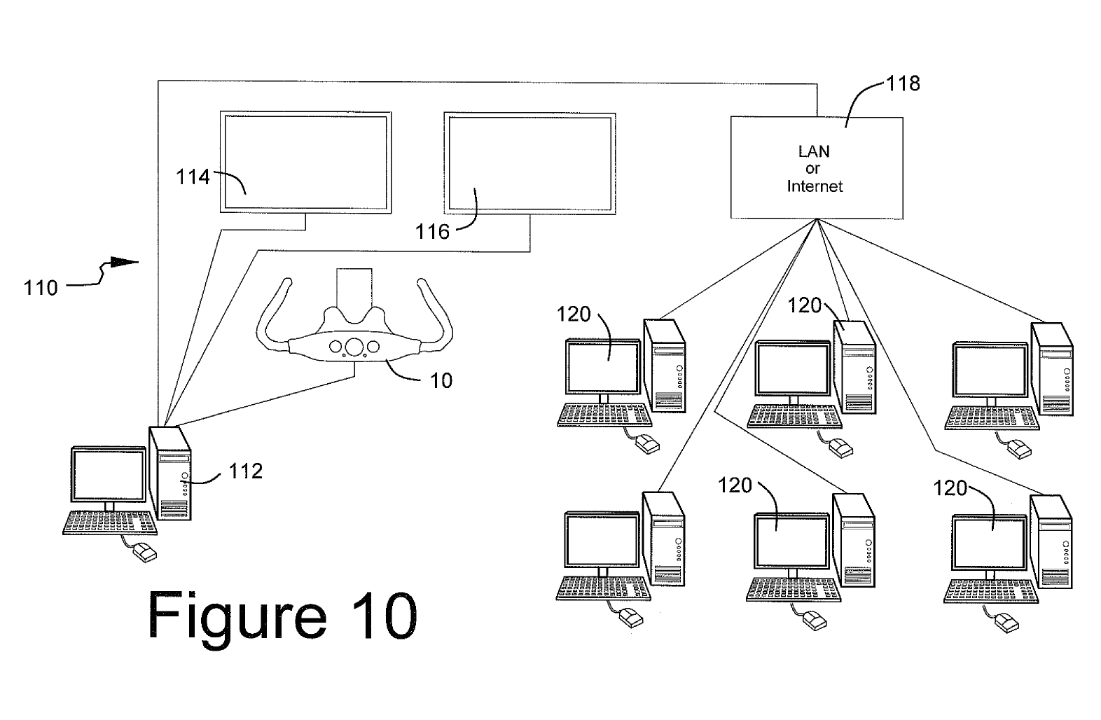

Referring to FIG. 10, a dental instruction system constructed in accordance with the present invention is illustrated. System 110 comprises the inventive dental video unit 10 whose output and control input signals are coupled to an external processing unit. An instructor's personal computer 112 is also coupled to a pair of large high-definition screens 114 and 116.

Computer 112 is linked via a network 118 to a plurality of student computers 120 which include mouse, keyboard and microphone capability to allow communication with the instructor where necessary, for example if the instruction is done over the Internet.

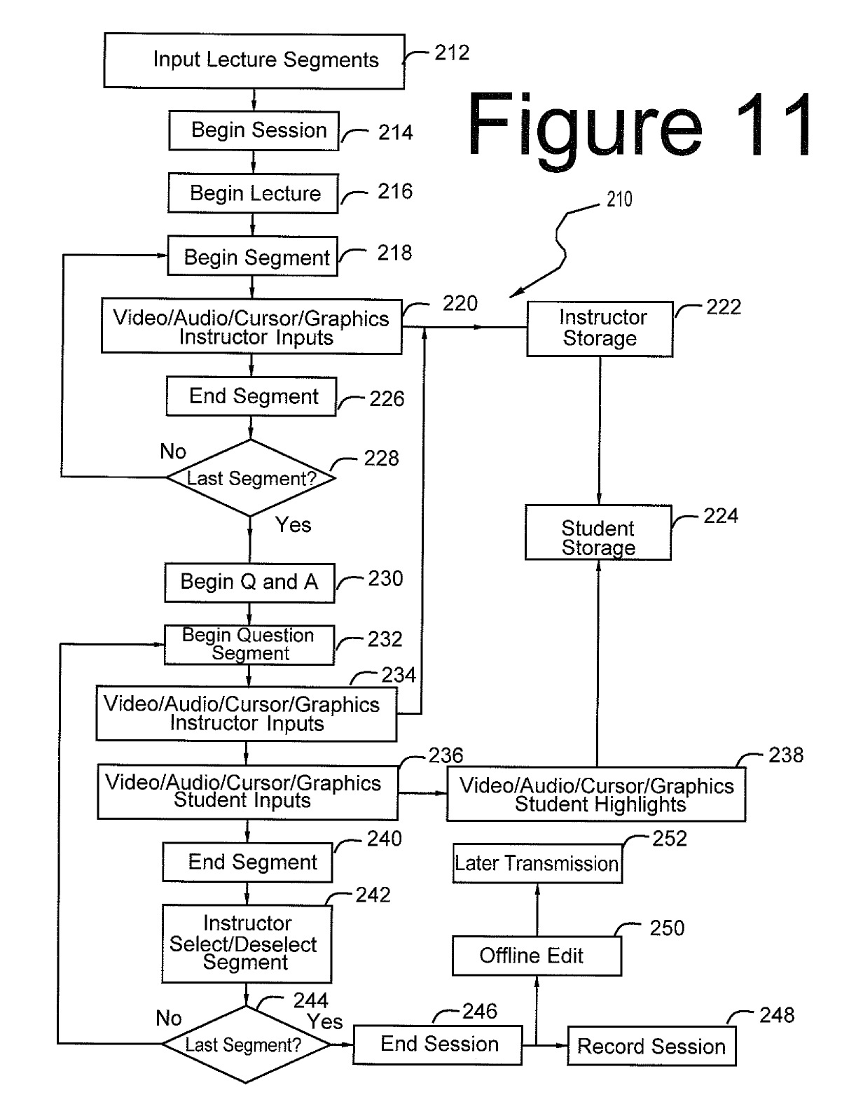

The operation 210 of system 110 may be understood with reference to FIG. 11. In accordance with the invention, it is contemplated that instruction will involve two parts, namely, instructor instruction and student questions. It is further contemplated that questions may be reserved to a question and answer session after the demonstration, for example, of a procedure. However, in accordance with the invention, students may be permitted to ask questions during the procedure and after such a question during the procedure, the system would return to the instruction portion at the appropriate point. For purposes of illustration, FIG. 11 illustrates a system in which the question-and-answer period is separate.

In accordance with the invention it is contemplated that initially the instructor will input lecture segments at step 212 into his computer and will use this as a template to label various parts of the instruction. For example, the lecture may be divided into segments denominated, for example, in the case of a root canal, as anesthetic, decay removal, preparing the surface for a cap, drilling the canal, nerve removal, mounting the post, taking the impression and installing a temporary protective restoration.

The instructor is then prepared to begin the session at step 214 by turning on the computer and the inventive video unit 10. The instructor then continues by placing the inventive video unit and its associated camera in position and beginning to lecture. Initially, the instructor starts by beginning to input audio and video at step 216, thus beginning the first segment which is bookmarked at step 218.

The system then proceeds to step 220 where the video, audio, cursor movement and input graphics, for example graphics marking up the video picture, all of which are generated by the instructor, are stored on the system in real time at step 222 for later use by the instructor. At step 224, this information is also stored on the student's personal computer.

At step 226, the instructor, through the use of a hyperlink, soft key, or the like, signals the end of the first segment. It is not the last segment, the instructor begins the next segment at step 218.

Alternatively, if it is the last segment in the lecture or instructional portion, the system proceeds to step 230 upon receiving the associated input from the instructor. This begins the question-and-answer portion of the session.

In similar fashion, at step 234, video, audio, cursor, graphic and perhaps other instructor inputs are input into the system during the question-and-answer session. These templates are stored at step 222 in the memory of the instructor's personal computer. In addition, they are stored in the memory of the student's personal computer at step 224.

At step 236, video, audio, cursor, graphic and perhaps other student inputs are input into the system. Such inputs correspond to notes which a student might take on his own during the question-and-answer session. If desired such inputs may also be entered by the student into the storage of the student's computer at step 224 during the initial instruction or lecture portion of the session which precedes the question-and-answer portion of the session. All such student inputs are stored on the student's personal computer at step 238.

The end of a particular question segment is indicated by an input from the instructor into the instructor's personal computer at step 240. At step 242, the instructor can decide whether to include the particular question in the permanent recording of the session. When the last question segment has occurred, this is indicated to the system by an appropriate input sent to the computer to have a session terminated at step 246. If the question-and-answer session was not ended the system returns to step 232 for the beginning of another question segment.

In accordance with the invention, it is contemplated that off-line editing may be performed at step 250. The edited version may be sent for transmission of a later time at step 252.

In accordance with the invention numerous functionalities may be provided, including, instructor audio, instructor video, component control of the system, movement by moving the inventive light and/or software adjustment of light position, and student audio.

Student and instructor ability to electronically control the cursor on the large instructor screens may also be provided, optionally with student and instructor having the ability to zoom in and zoom out. These controls can be computer controls or may be done in other manners. Likewise, provision may be made for both the student and instructor to click and drag images. If desired software may allow the instructor the ability to add alphanumeric information. Likewise, student and instructor editing may both be done.

Graphics may include highlighting, circling, arrows, or the like. Students may be provided the opportunity to be recognized using the computer and when the instructor receives such an input, it may give the identity of the student to the professor. When a request to be recognized is accepted, the system can automatically start a new question segment with a segment bookmark. The instructor may have the capability to end question segments.

On the other hand, the student has control over what may be viewed as his notebook, allowing different and unique student selections plus student notes.

The system may also allow and provide for the assessment of student inclusions and exclusions (if exclusions are allowed), or student activity with respect to certain parts of the instruction, and these may be tallied to assess advisability of including what might otherwise have been instructor rejected segments in a final product, or rejecting what might otherwise have been instructor included segments.

In accordance with the invention, one or a number of convex lenses may be used as closeup lenses in conjunction with the inventive video unit. The invention also contemplates the use of a single LED in place of the ring of light emitting diodes, and in such case, each of the two light emitting diodes may be provided with its own focusing system. Likewise, focusing systems involving cylindrical lenses with, for example, vertical orientations may be used in accordance with the present invention.

While an illustrative embodiment of the invention has been described, it is noted that various modifications may be apparent to those of ordinary skill in the art in view of the above description and drawings. Such modifications are within the scope of the invention which is limited and defined only by the following claims.

What is claimed:

1. Apparatus for generating and recording video and audio associated with a dental procedure, comprising:
(a) a video camera comprising a lens including an outermost refractive element, said lens having an optical axis;
(b) a light source comprising a plurality of light emiting devices, said light source being positioned adjacent said lens, said lens comprising an outer cylindrical surface, said outer cylindrical surface serving as a shade preventing light from entering said outermost refractive element;
(c) a support member for supporting said video camera at a plurality of positions;
(d) an instructor computer coupled to said video camera for recording video output by said video camera; and
(e) an instructor graphics input device coupled to said computer for inputting graphical representations generated by said instructor into said instructor computer for inclusion in said video.

2. Apparatus as in claim 1, further comprising:,
(f) a plurality of student computers coupled to receive the video output of said camera and said graphical representations generated by said instructor, and record the video output of said camera and said graphical representations generated by said instructor on said student computers; and
(g) a plurality of student graphics input devices, each associated with a student computer for inputting graphical representations generated by said student into his or her respective student computer for inclusion in said video.

3. Apparatus as in claim 1, wherein the input face of said lens and said light source are roughly in the same plane.

4. Apparatus as in claim 1, wherein said light source comprises a plurality of light emitting devices.

5. Apparatus as in claim 4, wherein a first group of said light emitting devices are positioned a first distance from said optical axis of said lens, and a second group of said light emitting devices are positioned a second distance from said optical axis of said lens, said second distance being greater than said first distance, said first group of said light emitting devices being oriented to illuminate an object at a first object distance from said lens along said optical axis of said lens, and said second group of said light emitting devices being oriented to illuminate an object at a second object distance from said lens along said optical axis, said second object distance being greater than said first object distance.

6. Apparatus as in claim 5, further comprising:,
(f) a plurality of student computers coupled to receive the video output of said camera and said graphical representations generated by said instructor, and record the video output of said camera and said graphical representations generated by said instructor on said student computers; and
(g) a plurality of student graphics input devices, each associated with a student computer for inputting graphical representations generated by said student into his or her respective student computer for inclusion in said video.

7. A method of using the apparatus of claim 6, wherein said instructor or other person edits the recorded program and transmits the same over a network to an audience.

8. Apparatus as in claim 6, wherein said instructor computer has a memory with a data structure comprising a first memory divided into a plurality of instruction segment sectors, and a second memory divided into a plurality of question and answer segment sectors.

9. Apparatus as in claim 6, wherein each of said student computers is coupled to a respective audio input.

10. A method of using the apparatus of claim 6, wherein audio and graphical inputs received from said student computers are recorded on said instructor computer, and wherein said instructor or other person edits the recorded program and transmits the same over a network to an audience.

11. Apparatus as in claim 1, wherein said light source comprises a plurality of light emitting devices, and wherein a first group of said light emitting devices are positioned a first distance from said optical axis of said lens, and a second group of said light emitting devices are positioned a second distance from said optical axis of said lens, said second distance being greater than said first distance, said first group of said light emitting devices being oriented to illuminate an object at a first object distance from said lens along said optical axis of said lens by producing a wide cone of light, and said second group of said light emitting devices being oriented to illuminate an object at a second object distance from said lens by producing said optical axis along a narrow cone of light, said second object distance being greater than said first object distance.

12. Apparatus for generating and recording video and audio associated with a procedure, comprising:
(a) a video camera comprising a lens including an outermost refractive element, said lens having an optical axis;
(b) a light source comprising a plurality of light emitting devices, said light source being positioned adjacent said lens, said lens comprising an outer cylindrical surface, said outer cylindrical surface serving as a shade preventing light from entering said outermost refractive element;
(c) a support member for supporting said video camera at a plurality of positions;
(d) an instructor computer coupled to said video camera for recording video output by said video camera;
(e) an instructor graphics input device coupled to said computer for inputting graphical representations generated by said instructor into said instructor computer for inclusion in said video;
(f) a plurality of student computers coupled to receive the video output of said camera and said graphical representations generated by said instructor, and record the video output of said camera and said graphical representations generated by said instructor on said student computers; and
(g) a plurality of student graphics input devices, each associated with a student computer for inputting graphical representations generated by said student into his or her respective student computer for inclusion in said video.
